(19) United States
(12) Patent Application Publication
(10) Pub. No.: US 2012/0080997 A1
(43) Pub. Date: Apr. 5, 2012

(54) IMAGE DISPLAY APPARATUS

(75) Inventors: Koji Yamazaki, Ayase-shi (JP); Akira Hayama, Sagamihara-shi (JP)

(73) Assignee: CANON KABUSHIKI KAISHA, Tokyo (JP)

(21) Appl. No.: 12/897,610

(22) Filed: Oct. 4, 2010

(51) Int. Cl. H01J 1/88

(52) U.S. Cl. 313/292

(57) ABSTRACT

A spacer positioned between a faceplate and a rear plate so as to extend across a first region on which an anode is provided and into a second region on which the anode is not provided is included. The spacer includes a plurality of conductive members extending across a first section of a side surface of the spacer that underlies the first region and into a second section of the side surface of the spacer that underlies the second region, distances from the faceplate to the conductive members differing from each other. The plurality of conductive members have an end portion in the second section. The position of the end portion of a conductive member farther from the faceplate is farther from the end portion of the anode.

### TECHNICAL FIELD

The present invention relates to an image display apparatus that includes a spacer.

### BACKGROUND ART

As display apparatuses, which are replacing cathode-ray tube type display apparatuses, thin display apparatuses are being studied in which a rear plate, which includes a plurality of electron-emitting devices, and a faceplate, which includes light-emitting members that emit light upon being bombarded with electrons, are arranged to face each other with a space of about a few millimeters therebetween by arranging a spacer that has a supporting structure that withstands atmospheric pressure therebetween. In such a display apparatus, a high voltage of a few hundred V or higher is applied between the rear plate and the faceplate, which have a space of a few millimeters therebetween, and thus there is concern about the occurrence of electric discharge along surfaces of the spacer. As a measure against this, in PTL 1, a spacer that is a plate-like spacer that is longer than an electron emission region and that includes a plurality of stripe-shaped conductive films that are longer than the electron emission region and are formed on side surfaces of the spacer is disclosed.

### CITATION LIST

### Patent Literature

PTL 1 Japanese Patent Laid-Open No. 2000-251648

However, in the technology disclosed in PTL 1, a structure that reduces electric field concentration to a greater degree at a section of the spacer that faces the faceplate and at an end portion of the spacer in the direction of the length of the spacer is desired.

The present invention aims to provide an image display apparatus that reduces electric field concentration at a section of a spacer that faces a faceplate and at an end portion of the spacer in the direction of the length of the spacer.

### SUMMARY OF INVENTION

In an aspect of the present invention, an apparatus that includes a rear plate configured to have an electron-emitting device; a faceplate configured to have an anode on part of a region of a surface that faces the electron-emitting device; and a spacer configured to be positioned between the faceplate and the rear plate so as to extend across a first region of the faceplate on which the anode is provided and into a second region of the faceplate on which the anode is not provided. The spacer has a plurality of conductive members extending across a first section of a side surface of the spacer that underlies the first region and into the second section of the side surface of the spacer that underlies the second region, distances from the faceplate to the conductive members differing from each other. The plurality of conductive members have an end portion in the second section, and the position of the end portion of a conductive member farther from the faceplate is farther from the end portion of the anode in a direction parallel to the side surface of the spacer on which the end portion is positioned and parallel to the surface of the faceplate.

Further features of the present invention will become apparent from the following description of exemplary embodiments with reference to the attached drawings.

### BRIEF DESCRIPTION OF DRAWINGS

FIG. 1 is a cutaway perspective view of an image display apparatus of an embodiment of the present invention.

FIGS. 2A to 2C are partial views illustrating extracted part of the structure of the image display apparatus of the embodiment of the present invention.

FIGS. 3A to 3C are partially sectional views of an image display apparatus of a comparison embodiment of the present invention.

FIGS. 4A to 4C are partially sectional views of the image display apparatus of the embodiment of the present invention.

FIG. 5 is a diagram of a potential distribution at a top end section of a spacer.

FIGS. 6A to 6C are partially sectional views illustrating an image display apparatus of an example of the present invention and image display apparatuses of comparison examples of the present invention.

### DESCRIPTION OF EMBODIMENTS

In the following, preferred embodiments of the present invention will be described with reference to the drawings.

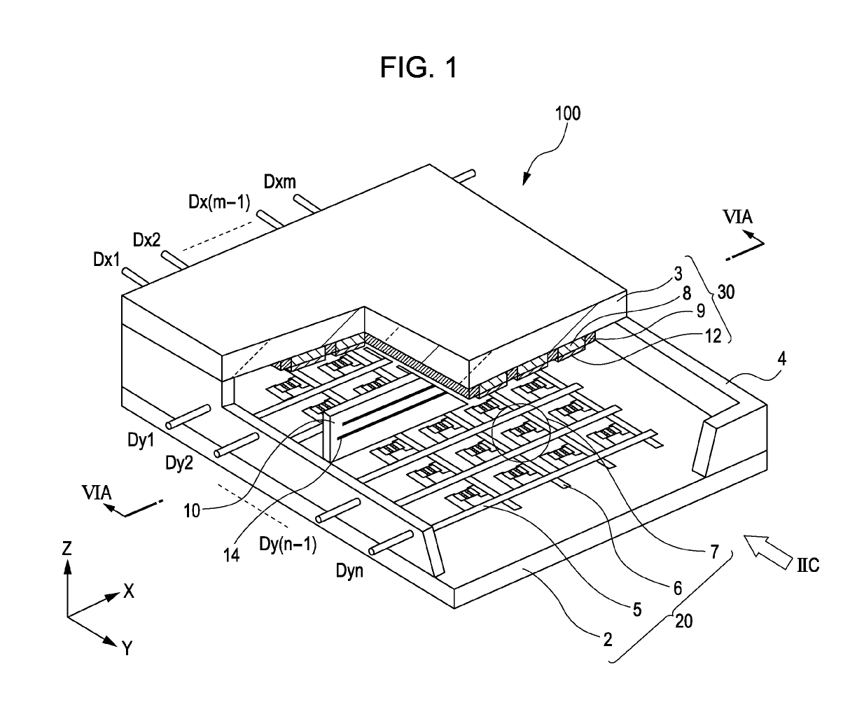

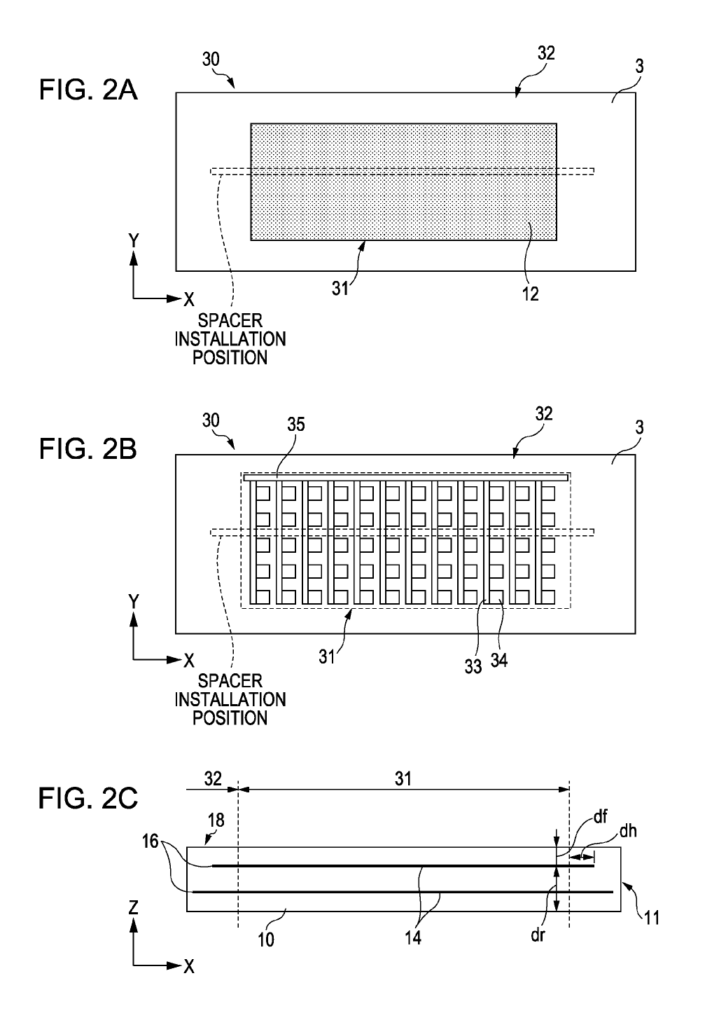

FIG. 1 is a perspective view of an image display apparatus of the present embodiment, and part of the image display apparatus has been cut away in order to show the internal structure. FIG. 2A is a plan view of a faceplate 30 of the image display apparatus of FIG. 1 as seen from a rear plate 20 side. FIG. 2C is a side view of a spacer 10 as seen in the direction indicated by a non-shaded arrow in FIG. 1.

As illustrated in FIG. 1, the rear plate 20 and the faceplate 30 are joined together by a frame 4 therebetween to form an image display apparatus 100. The rear plate 20 includes a back substrate 2, row wirings 5 and column wirings 6 arranged on the back substrate 2, and electron-emitting devices 7, each of which is electrically connected to a row wiring 5 and a column wiring 6. Moreover, the faceplate 30 includes a front substrate 3 and anodes 12 on part of a region of this front substrate 3. The anodes 12 are arranged on a surface of the front substrate 3 that faces the electron-emitting devices 7. The spacer 10 is provided between the rear plate 20 and the faceplate 30. In the present embodiment, the spacer 10 is provided, which is a conductive plate-like spacer electrically connected to the electron-emitting devices 7 via the anodes 12 and a row wiring 5. Here, a plurality of conductive members 14 that are at different distances from the faceplate are provided on a side surface of the spacer 10, the conductive members 14 being in parallel with the surface of the faceplate on which the anodes are provided. In the present embodiment, stripe-shaped (strip-shaped) conductive members are used as the conductive members 14. Here, the side surface of the spacer 10 is a surface exposed to the space between the faceplate 30 and the rear plate 20, and is a surface of the plate-like spacer, as in the present embodiment, that is parallel to the X-Z plane in the drawing. As illustrated in FIG. 2A, the spacer 10 extends across a region 31 of the faceplate on which an anode is provided and into a region 32 of the faceplate on which the anode is not provided. Moreover, as illustrated in FIG. 2C, the plurality of conductive members 14 are positioned so as to extend across a section of the side surface of the spacer that underlies the region on which the anode is provided and into sections of the side surface of the spacer that underlie the region on which the anode is not provided, and include end portions 16 in the sections that underlie the region on which the anode is not provided. Here, a section of the side surface of the spacer that underlies the region on which the anode is provided means a section of the side surface of the spacer that the projected image of the anode crosses when the anode 12 is vertically projected onto the rear plate 20, and is a section of the side surface of the spacer sandwiched between dotted lines that represent the end portions of the region 31, on which the anode is provided, in FIG. 2C. Moreover, sections of the side surface of the spacer that underlie the region on which the anode is not provided mean sections of the side surface of the spacer that the projected image of the anode does not cross when the anode 12 is vertically projected onto the rear plate 20, and are sections of the side surface of the spacer sandwiched between dotted lines that represent the end portion of the region 32, on which the anode is not provided, in FIG. 2C. The end portion 16 of a conductive member 14 farther from the faceplate is farther from the end portion of the anode in a direction parallel to the side surface of the spacer on which the end portion 16 is positioned and parallel to the surface of the faceplate on which the anode is provided. Here, in the present example, the direction parallel to the side surface of the spacer on which the end portion 16 of the conductive member 14 is positioned and parallel to the surface of the faceplate on which the anode is provided, which is the direction in which the conductive members 14 extend, is the x direction in the drawing. Moreover, in the following, the direction parallel to the side surface of the spacer on which the end portion 16 of the conductive member 14 is positioned and parallel to the surface of the faceplate on which the anode is provided, which is the direction in which the conductive members 14 extend, may be simply called a direction in which the conductive members extend. As described above, electric field concentration at a section 18 of the spacer that faces the surface of the faceplate on which the anode is provided and at end portions 11 of the spacer in the direction in which the conductive members extend can be reduced by controlling the positions of the end portions 16 of the conductive members 14. As a result, electric discharge occurring at the section 18 of the spacer that faces the surface of the faceplate on which the anode is provided and at the end portions 11 of the spacer in the direction in which the conductive members extend can be suppressed. With regard to this, the details will be described below. Here, in the following, the section of the spacer that faces the surface of the faceplate on which the anode is provided may be simply expressed as the top end of the spacer.

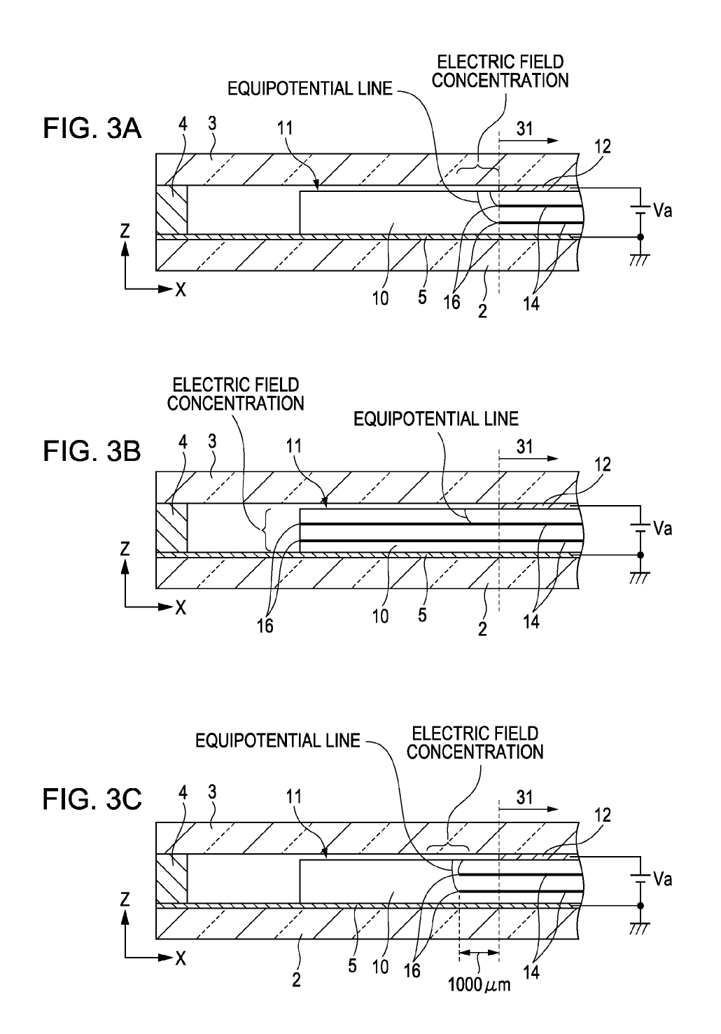

The present inventors and the like diligently performed studies, so that the present inventors and the like found that the position of each of the end portions 16 of the plurality of conductive members 14 formed on the side surface of the spacer with respect to the position of the end portion of the anode 12 in the direction in which the conductive members 14 extend affected the state of a potential distribution at the top end 18 of the spacer and at the end portions 11 of the spacer in the direction in which the conductive members extend. With regard to this, description will be made by using FIGS. 3A to 5.

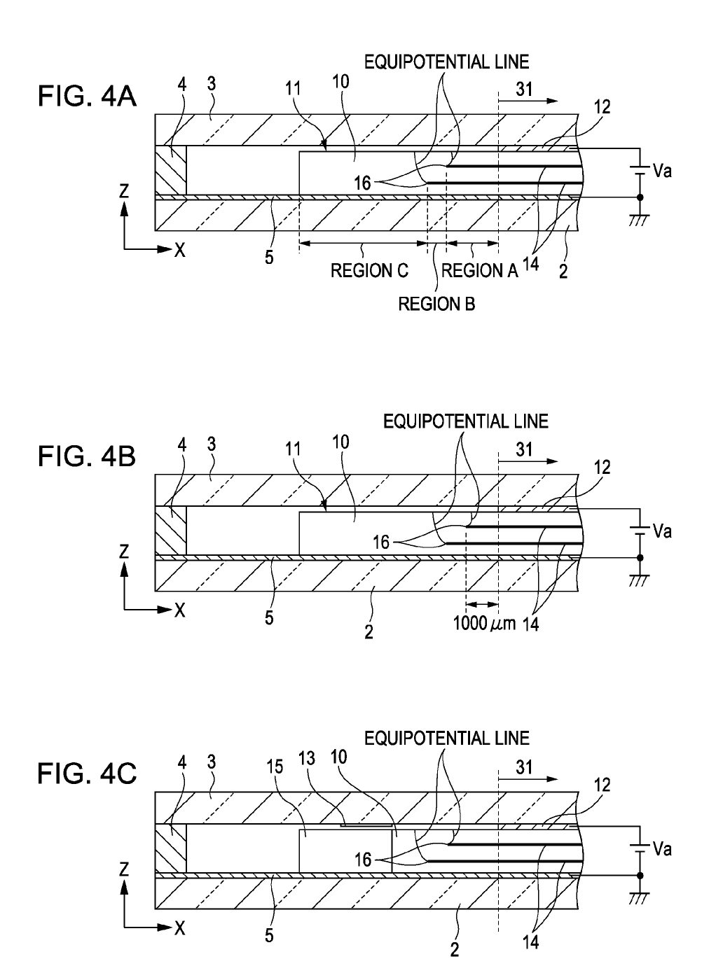

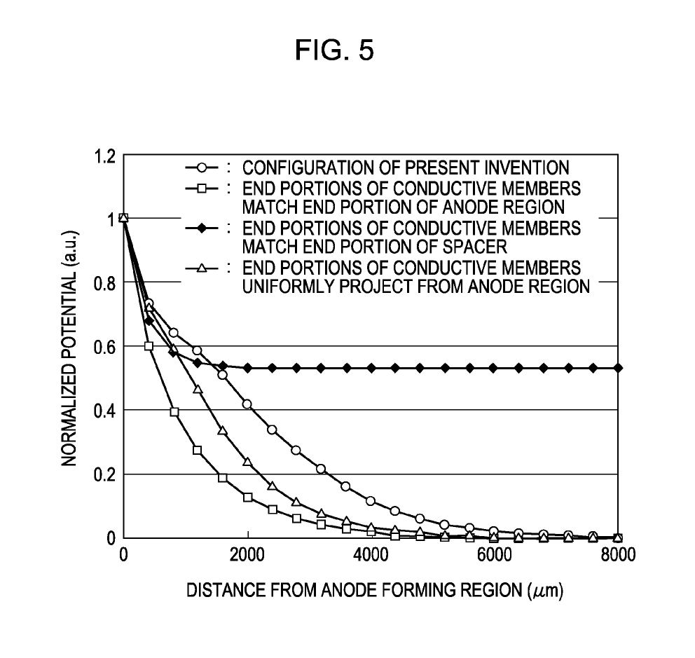

FIG. 5 illustrates the state of a potential distribution at the top end 18 of the spacer when the positions of the end portions 16 of the plurality of conductive members 14 formed on the side surface of the spacer in the direction in which the conductive members 14 extend are changed. The vertical axis of FIG. 5 represents a normalized potential that is obtained by normalizing the potential of the top end of the spacer by using an anode voltage. The horizontal axis represents a distance from the end portion of the anode to a top end section of the spacer, which is a section of the spacer facing the faceplate. Positions 8000 μm away from the end portion of the anode match the position of an end portion 11 of the spacer in the direction in which the conductive members 14 extend. Moreover, non-shaded squares (empty squares), black diamonds (solid diamonds), and non-shaded triangles (empty triangles) represent potential distributions at the top end of the spacers in the spacers illustrated in FIGS. 3A, 3B, and 3C, respectively, in the drawing. Any of these represents a potential distribution of the spacer that does not have the structure in which the position of the end portion 16 of a conductive member 14 farther from the faceplate on the side surface of the spacer is farther from the end portion of the anode 12 in the direction in which the conductive members 14 extend. Furthermore, the non-shaded squares (empty squares) represent a potential distribution of the spacer on which the conductive members 14 are positioned in the section of the side surface of the spacer that underlies the region of the faceplate on which the anode is provided but does not extend into the sections that underlie the region on which the anode is not provided. More specifically, the potential distribution of the spacer on which the positions of the end portions 16 of the conductive members 14 on the side surface of the spacer are made to match the end portion of the anode 12 illustrated in FIG. 3A is illustrated. Moreover, the black diamonds (solid diamonds) represent a potential distribution of the spacer on which the end portions 16 of the conductive members 14 are made to match the end portion 11 in the direction in which the conductive members 14 illustrated in FIG. 3B extend. Moreover, individual non-shaded triangles (empty triangles) represent a potential distribution of the spacer on which the position of the end portions 16 of all the conductive members 14 on the side surface of the spacer uniformly (1000 μm in the present example) and outwardly extend from the end portion of the anode 12 illustrated in FIG. 3C in the direction in which the conductive members 14 extend. In contrast, white circles (empty circles) represent a potential distribution at the top end of the spacer in the spacer according to an embodiment of the present invention, on which the position of the end portion 16 of a conductive member 14 farther from the faceplate on the side surface of the spacer illustrated in FIG. 4A is farther from the end portion of the anode 12 in the direction in which the conductive members 14 extend. Here, in the present example, each of the end portions 16 of the conductive members 14 is away from the end portion of the anode 12 by 1500 μm or 3000 μm in the direction in which the conductive members 14 extend, in such a manner that the end portion 16 of a conductive member 14 farther from the faceplate is farther from the end portion of the anode 12. Moreover, as any of the spacers, a spacer whose size in the Z direction in the drawings is 1.6 mm is used. As illustrated in FIG. 5, in the spacer (empty squares) illustrated in FIG. 3A, the potential of the top end of the spacer suddenly drops to the anode voltage multiplied by about 0.1 at the top end section of the spacer a little less than 2000 μm, which is almost equal to the size of the spacer in the Z direction, away from the end portion of the anode. It is recognized that the potential suddenly and significantly changes within an extremely narrow area around the end portion of the anode 12. Moreover, in the spacer (solid diamonds) illustrated in FIG. 3B, the potential of the top end 18 of the spacer remains at about the anode voltage multiplied by 0.6. Thus, the potential of this section does not suddenly and significantly change; however, in contrast, although not illustrated, the potential of the end portion 11 of the spacer 10 in the direction in which the conductive members 14 extend suddenly drops from the anode voltage multiplied by about 0.6 to 0 V, and thus the potential of this section significantly changes. Moreover, in the spacer (empty triangles) illustrated in FIG. 3C, change in potential of the top end of the spacer is relatively small at the top end section of the spacer 1000 μm away from the end portion of the anode 12, that is, in the top end section having a length of the distance from the end portion of the anode 12 to the end portions 16 of the conductive members 14 in the direction in which the conductive members 14 extend. However, the potential of the top end of the spacer suddenly drops from the anode voltage multiplied by 0.6 to the anode voltage multiplied by 0.1 in a region farther from that, that is, a region from 1000 μm to a little less than 3000 μm. It is recognized that the potential suddenly and significantly changes in this region. In contrast to these, in the spacer (empty circles) of the present invention illustrated in FIG. 4A, the potential distribution from the end portion of the anode 12 to a point about 1000 μm away from the end portion of the anode 12 is almost the same as in the spacer (solid diamonds) illustrated in FIG. 3B and the spacer (empty triangles) illustrated in FIG. 3C. However, it is recognized that the potential of the top end of the spacer gradually declines to the anode voltage multiplied by 0.1 from that point to the top end section of the spacer 5000 μm away from the end portion of the anode 12. As described above, with the structure of the present invention, the potential is not caused to drop suddenly and significantly, and thus electric field concentration at the top end of the spacer can be reduced and the occurrence of electric discharge due to electric field concentration at the top end of the spacer can be reduced. In addition, since the potential of the top end 18 of the spacer 10 is dropped to about 0 V, there is no change in potential of the end portion 11 of the spacer 10 in the direction in which the conductive members 14 extend. Thus, electric discharge due to electric field concentration also does not occur at this section. As a result, an image display apparatus whose operation is stable can be provided. Here, even when the positions of the end portions 16 of the conductive members 14 in the direction in which the conductive members extend differ from the positions illustrated in FIG. 4A, it has been confirmed that the potential of the top end of the spacer gradually declines. For example, as illustrated in FIG. 4B, even when the distances from the end portion of the anode are set to 1000 μm and 1500 μm in the direction in which the conductive members 14 extend, in such a manner that the position of the end portion 16, in the direction in which the conductive members extend, of a conductive member 14 farther from the faceplate 30 is farther from the end portion of the anode 12 in this direction, it has been confirmed that the potential of the top end of the spacer gradually declines. That is, similarly to the above-described spacer illustrated in FIG. 3C, even when the conductive member that is closer to the anode projects outwardly by 1000 μm from the end portion of the anode, electric field concentration can be reduced similarly to FIG. 4A by designing the end portion of a conductive member farther from the faceplate than this conductive member to be farther from the end portion of the anode. Moreover, although not illustrated, even when the distances from the end portion of the anode are set to 600 μm and 1000 μm in the direction in which the conductive members 14 extend, in such a manner that the position of the end portion 16, in the direction in which the conductive members extend, of a conductive member 14 farther from the faceplate 30 is farther from the end portion of the anode 12 in this direction, it has been confirmed that the potential of the top end of the spacer gradually declines. Hence, it is recognized that the conductive members 14 have the end portions 16 in the section of the side surface of the spacer that underlies the region 32 of the faceplate 30 on which the anode 12 is not provided, and what is important is that the end portion 16 of a conductive member 14 farther from the faceplate 30 is farther from the end portion of the anode 12 in the direction in which the conductive members 14 extend.

Here, the relationship between the positions of the end portions 16 of the conductive members 14 positioned on the side surface of the spacer in the direction in which the conductive members 14 extend and the potential distribution of the top end 18 of the spacer is considered as follows. Although the potential of the top end 18 of the spacer in the region 31 on which the anode 12 is provided is defined by the potential of the anode 12, the potential of the top end 18 of the spacer in the region 32 on which the anode 12 is not provided is affected by the potentials of the conductive members 14 located in the region 32 on which the anode 12 is not provided and the potentials of electron-emitting devices (more specifically, the potential of the row wiring 5 in the above-described individual examples) located in the region 32 on which the anode 12 is not provided. This will be described for individual examples in FIGS. 3A, 3B, and 3C and FIG. 4A. In FIG. 3A, an electric-field-concentration spot occurs by being markedly affected by the potentials of the electron-emitting devices (here, the potential of the row wiring 5) at the top end 18 of the spacer that faces the section of the region 32 on which the anode is not provided since the conductive members 14 are not positioned on the section of the side surface of the spacer that underlies this region. More specifically, since the conductive members 14 are not positioned on the section of the side surface of the spacer that underlies the region 32 on which the anode 12 is not provided, the potential of the top end 18 of the spacer within a region about 1.6 mm, which is the size of the spacer in the Z direction, away from the end portion of the anode 12 is pulled by the potentials of the electron-emitting devices and suddenly drops, so that the electric field concentration occurs in this region. Moreover, in FIG. 3B, the potentials of the electron-emitting devices are shielded by the conductive members 14 at the top end 18 of the spacer that faces the section of the region 32 on which the anode is not provided since the conductive members 14 are positioned across the entire section of the side surface of the spacer that underlies this region. Thus, the potential of the top end 18 of the spacer that faces the region 32 is affected by only the potentials of the conductive members 14 positioned on the section of the side surface of the spacer that underlies the region 32, and is maintained at the potential of the conductive member that is closer to the anode (about the anode voltage multiplied by 0.6 in this example). Note that, as described above, an electric field concentrates at the end portion 11 of the spacer 10 in the direction in which the conductive members 14 extend. Moreover, in FIG. 3C, a potential shield generated by one of the conductive members 14 that is closer to the anode prevents the potentials of the electron-emitting devices from being affected at the top end section of the spacer 1000 μm away from the end portion of the anode 12, that is, in the top end section having a length of the distance from the end portion of the anode 12 to the end portions 16 of the conductive members 14 in the direction in which the conductive members 14 extend. However, the potential is pulled by the potentials of the electron-emitting devices and suddenly drops in a region of the top end 18 of the spacer away from the end portion of the anode by 1000 μm or more, so that electric field concentration occurs. As described above, any of the spacers in FIGS. 3A, 3B, and 3C is not configured in such a manner that the position of the end portion 16 of a conductive member 14 farther from the faceplate on the side surface of the spacer is farther from the end portion of the anode 12 in the direction in which the conductive members 14 extend. Thus, the potential is biased. In other words, since the positions of the end portions of the conductive members 14 are aligned, a potential shield is provided, before the positions of the end portions of the conductive members 14, by the conductive member that is closer to the anode and the potential is not affected by the potentials of the electron-emitting devices. However, in a region beyond that, the potential is suddenly pulled by the potentials of the electron-emitting devices and suddenly and significantly drops, so that electric field concentration occurs. In contrast, in FIG. 4A, because of the action of the potential shield of each of the conductive members, the potential of the top end of the spacer in each of the regions A, B, and C is affected by the potential of one of the conductive members 14 that is closer to the anode, the potential of one of the conductive members 14 that is closer to the electron-emitting devices, and the potentials of the electron-emitting devices, respectively. Thus, the potential is not suddenly pulled by the potentials of the electron-emitting devices, and gradually declines to a potential of the electron-emitting devices from the region A to the region C. As described above, the potential of the top end 18 of the spacer 10 and the potential of the end portion 11 of the spacer 10 in the direction in which the conductive members 14 extend can be controlled by controlling, within the region 32 on which the anode is not provided, the positions of the end portions of the conductive members 14 in the direction in which the conductive members 14 extend. As a result, electric discharge at a surface of the spacer can be suppressed.

Here, as illustrated in FIG. 4C, when the structure is used in which a low-potential electrode 13, which is defined to have a lower potential than the anode 12, is provided in the region 32 of the faceplate 30 on which the anode 12 is not provided and an end-portion electrode 15, which is defined to have the same potential as the low-potential electrode 13, is provided on a section of the side surface of the region of the end portion 11 of the spacer, it has been confirmed that sudden and significant change in potential of the top end of the spacer is suppressed by having a structure in which the position of the end portion 16 of a conductive member 14 farther from the faceplate is farther from the end portion of the anode 12 in the direction in which the conductive members 14 extend. Moreover, as illustrated in FIG. 2C, it is desirable that a distance df between at least one of the conductive members (the conductive member that is closer to the top end 18 of the spacer in the example in FIG. 2C) and the faceplate 30 and a distance dh between the end portion of the anode 12 and the end portion 16 of this conductive member 14 in the direction in which the conductive members 14 extend satisfy dh df. This can cause the potential distribution at the top end 18 of the spacer to be broadened in the direction away from the end portion of the anode. Thus, sudden and significant change in potential of the top end of the spacer can be reduced to a greater degree. Furthermore, it is more desirable that a distance dr between this conductive member 14 and the rear plate 20 satisfy dr>df and that dh≧df be satisfied. This can effectively suppress sudden and significant change in potential, which especially tends to be a factor that causes electric discharge, of the top end 18 of the spacer near the end portion of the anode 12 and thus electric discharge can be suppressed more assuredly. Here, in FIGS. 3A to 4C, although only the end portion 11 of one side of the spacer 10 has been illustrated and described, it is more desirable that the above-described conditions be satisfied at the end portions 11 of both sides of the spacer. Moreover, the spacer 10 is not limited to a plate-like spacer. The present invention may also be applied to spacers having various shapes such as a spacer having a square-column shape or a cylindrical shape.

Next, individual constructional elements according to the present embodiment will be described by using FIG. 1.

The rear plate 20 includes the back substrate 2 and the electron-emitting devices 7, the row wirings 5, and the column wirings 6 that are provided on a surface of the back substrate 2. A glass, a ceramic, or the like may be used for the back substrate 2. In the present embodiment, a glass that is highly resistant to strain such as PD200 may be preferably used. As the electron-emitting devices 7 provided on the back substrate 2, for example, surface-conduction emitter devices may be preferably used. Moreover, the row wirings 5 and column wirings 6 connected to the electron-emitting devices 7 may be formed by, for example, printing a metal paste. An electron can be emitted from a desired electron-emitting device 7 by inputting a scanning signal to a row wiring 5 and an information signal to a column wiring.

The faceplate 30 includes the front substrate 3 and light-emitting members 8, a black member 9, and the anode 12 that are provided on a surface of the front substrate 3. As the front substrate 3, a member that allows visible light to pass therethrough such as a glass may be used. In the present embodiment, similarly to the back substrate, a glass that is highly resistant to strain such as PD200 may be preferably used. For the light-emitting members 8, phosphor crystal that emits light by being subjected to electron beam pumping may be used. As specific phosphor materials, for example, phosphor materials and the like that are described in “Phosphor Handbook” edited by the Phosphor Research Society (Published by Ohmsha) and those that are used in existing CRTs and the like may be used. As the black member 9, a black matrix structure known for being used in CRTs and the like may be employed. In general, the black member 9 is composed of black metal, black metal oxide, carbon, or the like. The black metal oxide may be, for example, ruthenium oxide, chromium oxide, iron oxide, nickel oxide, molybdenum oxide, cobalt oxide, copper oxide, or the like. As the anode 12, a metal back composed of Al or the like, which is known for being used in CRTs and the like, may be used. As patterning for the anode 12, a vapor deposition method using a mask, an etching method, or the like can be used. Since it is necessary to cause electrons to pass through the anode electrode 12 and reach the light-emitting members 8, the thickness of the anode electrode 12 is set as appropriate by considering energy loss of the electrons, a set acceleration voltage (the anode voltage), and a light reflection efficiency. When a voltage of 5 kV to 15 kV is applied to the anode electrode 12, the anode electrode 12 is set to have a thickness of 50 [nm] to 300 [nm]. Here, the faceplate is not limited to what illustrated in FIG. 2A which has been described above, and may be, for example, as illustrated in FIG. 2B, a faceplate having an anode structure in which a metal back 34 is divided into a plurality of pieces, the pieces are electrically connected by using resistor members 33, the resistor members 33 are connected to a high tension circuit, which is not illustrated, by a feeding electrode 35. In this case, even when electric discharge accidentally occurs between the anode structure and the electron-emitting devices of the rear plate, the scale of electric discharge can be made small and this is preferable.

As the spacer 10, a base member having the conductive members 14, which are formed on a side surface of the base member, may be used. As the base member, for example, a ceramic member such as a quartz glass, a glass whose amount of impurity such as Na is reduced, a soda-lime glass, or alumina, or the like may be used. It is desirable that a member whose thermal expansion coefficient is closely analogous to that of the back substrate 2, that of the front substrate 3, and that of the frame 4 be selected.

The conductive members 14 may be formed by a method in which a metal thin film is sputtered on a side surface of the spacer base member, or the like. Alternatively, a spacer can be formed by drawing a base member having conductive members formed on a surface of the base member into a spacer as a single unit by a heat drawing method. Here, as the conductive members 14, a material having a resistance that is sufficiently lower than that of the base material should be selected. For example, the material is selected as appropriate from among metals such as Ni, Cr, Au, Mo, W, Pt, Ti, Al, Cu, and Pd; alloys made by using the metals; conductors composed of, for example, a metal or a metal oxide and a glass such as Pd, Ag, Au, RuO₂, or Pd—Ag; transparent conductors such as In₂O₃—SnO₂; semiconductor materials such as polysilicon; and the like. Here, as a patterning method for the conductive members, a method in which pattern shaping is performed by a sputtering method using a mask, a method in which pattern shaping is performed on the conductive materials given onto the base member by a laser trimming method, or the like may be used. Here, it is preferable that a resistor film be further formed on the side surface of the spacer 10 and charging of the spacer be suppressed. Moreover, for the spacer base member, a material having a slight conductivity may be used instead.

The above-described faceplate 30, rear plate 20, and spacer 10 are prepared, and the spacer 10 is arranged between the faceplate 30 and the rear plate 20. Then, the outer edge of the faceplate 30 and that of the rear plate 20 are joined together by the frame 4 to form the image display apparatus 100.

When an image is displayed on the image display apparatus 100 formed as described above, a high voltage is applied to the anode 12 and a driving voltage is applied to the electron-emitting devices 7 by inputting scanning signals and information signals to the row wirings 5 and the column wirings 6, respectively, via terminals Dy and Dx, so that arbitrary electron-emitting devices 7 are caused to emit an electron beam. The electron beam emitted from an electron-emitting device 7 is accelerated by the high voltage of the anode 12 and collides with a light-emitting member 8. As a result, the light-emitting members 8 are selectively excited and caused to emit light, and an image is displayed.

### EXAMPLE

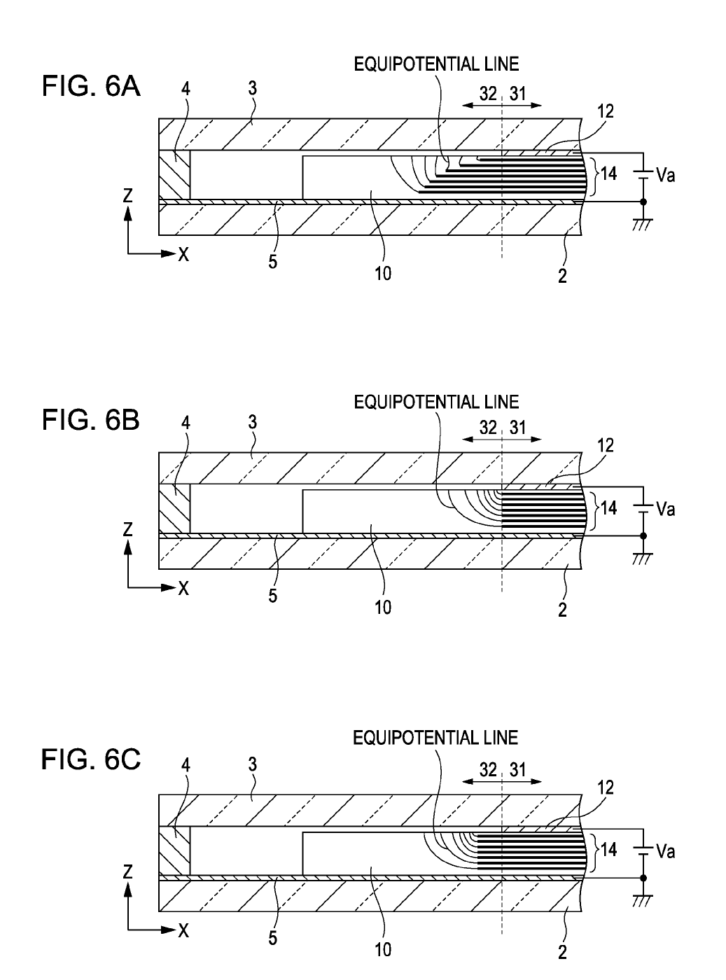

In the following, an example of the present invention will be described. Here, the rear plate and the entire structure of the image display apparatus have been described in the above-described embodiment, and thus characterizing portions of the present example will be specifically described. FIG. 6A is a partially sectional view, taken along line VIA-VIA, of the image display apparatus of the present example illustrated in FIG. 1. As illustrated in FIG. 6A, the spacer 10 extends across the region 31 of the faceplate on which the anodes 12 are provided and into the region 32 of the faceplate on which the anodes are not provided, the region 32 being an outer region of the region on which the anodes 12 are provided. Here, the spacer 10 is arranged on a row wiring 5 on the back substrate 2 of the rear plate, and is electrically connected to the electron-emitting devices 7, which are not illustrated, by the row wiring 5. The spacer 10 is arranged on the anodes 12 on the faceplate and is electrically connected to the anodes. Next, individual members, which are the faceplate, the spacer, and the rear plate, will be described by using FIG. 1 in this order.

The black member 9 is formed by printing a black paste on a surface of the front substrate 3 composed of PD200, which is a glass that is highly resistant to strain and that has a size of 1300 mm in the X direction and 800 mm in the Y direction, so as to have a size of 1210 mm in the X direction and 680.4 mm in the Y direction; and by performing patterning in which exposure and development are performed on the black paste so as to form a lattice shape by using a photolithographic technique. The pitch of opening portions of the lattice is made to be 630 μm in the Y direction and 210 μm in the X direction. The size of openings is made to be 295 μm in the Y direction and 145 μm in the X direction. Next, a paste in which a P22 phosphor used for the light-emitting members 8 in the field of CRTs is dispersed is used, and the phosphor, which will be light-emitting members, is printed into the openings by performing screen printing in accordance with the black member 9 having lattice-style openings. In the present example, three-color phosphors, which are R, G, and B phosphors, are selectively applied so as to form a color display, and each phosphor is made to have a film thickness of 15 μm. Next, after an acrylic emulsion has been applied by a spray coating method and dried and gaps formed by a phosphor powder have been filled with an acrylic resin, an aluminum film, which is to be the anode electrode 12, is deposited so as to have a size of 1209.8 mm in the X direction and 680 mm in the Y direction in such a manner that the aluminum film covers the phosphor members and the black member. Here, the aluminum film, which is the anode electrode 12, is made to have a thickness of 90 nm. As described above, the faceplate 30 is formed.

Next, the spacer 10 will be described. Seven conductive members 14 having a strip shape are formed by sputtering tungsten on a side surface (an XZ surface) of a glass base member having a size of 1226 mm in the X direction, which is longer than that of the above-described anode electrode 12 by 16.2 mm, 0.2 mm in the Y direction, and 1.6 mm in the Z direction. More specifically, the conductive members 14 are formed so as to have a size of 0.04 mm in the Z direction and 1211.4 mm, 1213 mm, 1214.2 mm, 1215 mm, 1215.6 mm, 1216 mm, and 1215.8 mm in the X direction, and so as to have a pitch of 0.2 mm in the Z direction. Here, the shortest conductive member and the longest conductive member are formed at a position 0.18 mm away from the top end portion and the bottom end portion of the spacer, respectively. Here, the top end portion and the bottom end portion of the spacer mean the end portions in the Z direction in the drawing. Moreover, the seven conductive members are formed on each of both XZ surfaces of the spacer.

Similarly to the faceplate 30, the rear plate 20 is created by forming the surface-conduction emitter devices 7, which are the plurality of electron-emitting devices described in the embodiment, the plurality of row wirings 5, and the plurality of column wirings 6 on the back substrate 2 composed of PD200, which is a glass that is highly resistant to strain.

After the faceplate 30, the rear plate 20, and the spacer 10 manufactured as described above have been well aligned, the outer edge of the faceplate 30 and that of the rear plate 20 sandwich the frame 4, which is composed of PD200, and are joined together by the frame 4, and the image display apparatus 100 illustrated in FIG. 1 is made. Here, the spacer is arranged in such a manner that the center of the region 31, which is illustrated in FIG. 6A and on which the anode is provided, in the X direction matches the center of the spacer 10 in the X direction with respect to the faceplate, and a conductive member 14 farther from the faceplate on a side surface of the spacer has a longer length in the X direction. As a result, both end portions of the conductive members 14 in the X direction on the side surfaces of the spacer protrude from the anode forming region 31 by 0.8 mm, 1.6 mm, 2.2 mm, 2.6 mm, 2.9 mm, 3.1 mm, and 3.3 mm from near the faceplate.

When a high voltage of 10 kV was applied to the anode 12 of the image display apparatus 100 created as described above and images were displayed by inputting scanning signals and information signals to the row wirings 5 and the column wirings 6, respectively, abnormal electric discharge was not recognized near the spacer during continuous operation for 1000 hours and images were displayed in a preferable manner. Here, for comparison, a spacer illustrated in FIG. 6B on which seven conductive members 14 whose lengths are all 1209.8 mm in the X direction were formed (the spacer being a spacer on which the end portions of the conductive members match the end portion of the anode, and hereinafter referred to as a comparison spacer A) was prepared. Moreover, a spacer illustrated in FIG. 6C on which seven conductive members 14 whose lengths are all 1211.8 mm in the X direction were formed (the spacer being a spacer on which the end portions of the conductive members protrude outwardly from the end portion of the anode by 1 mm, and hereinafter referred to as a comparison spacer B) was prepared. When image display apparatuses were similarly formed by using these comparison examples A and B and a voltage of 10 kV was applied to the anode 12 in the same way, electric discharge occurred in the image display apparatus using the spacer A when the anode voltage was increased to 7 kV. Moreover, abnormal electric discharge occurred in the image display apparatus using the spacer B when the anode voltage was increased to 9 kV. As described above, compared with the image display apparatuses that do not use the present invention, images were displayed in a preferable manner over a long period of time on the image display apparatus of the present example.

According to the present invention, an image display apparatus that reduces electric field concentration at a section of a spacer that faces a faceplate and at an end portion of the spacer in the direction of the length of the spacer can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of International Application No. PCT/JP2009/067486, filed Oct. 7, 2009, which is hereby incorporated by reference herein in its entirety.

What is claimed is:

1. An apparatus comprising:
a rear plate configured to have an electron-emitting device;
a faceplate configured to have an anode on part of a first region of a surface that faces the electron-emitting device; and
a spacer configured to be positioned between the faceplate and the rear plate so as to extend across the first region and into a second region of the faceplate,
wherein the spacer has a plurality of conductive members extending across a first section of a side surface of the spacer that underlies the first region and into a second section of the side surface of the spacer that underlies the second region, distances from the faceplate to the conductive members differing from each other, and
wherein the plurality of conductive members have an end portion in the second section, and the position of the end portion of a conductive member farther from the faceplate is farther from the end portion of the anode in a direction parallel to the side surface of the spacer on which the end portion is positioned and parallel to the surface of the faceplate.

2. The apparatus according to claim 1, wherein a distance df from the faceplate to at least one conductive member from among the plurality of conductive members and a distance dh from the end portion of the anode to the end portion of the at least one conductive member in the direction satisfy dh≧df.

3. The apparatus according to claim 2, wherein a distance dr from the rear plate to the at least one conductive member satisfies dr>df.
